(19) United States
(12) Patent Application Publication
(10) Pub. No.: US 2021/0313864 A1
(43) Pub. Date: Oct. 7, 2021

(54) ELECTRIC COMPRESSOR

(71) Applicant: SANDEN HOLDINGS CORPORATION, Isesaki-shi, Gunma (JP)

(72) Inventors: Dongyuan ZHANG, Isesaki-shi, Gunma (JP); Koji KOBAYASHI, Isesaki-shi, Gunma (JP)

(73) Assignee: SANDEN HOLDINGS CORPORATION, Isesaki-shi, Gunma (JP)

(21) Appl. No.: 17/259,955

(22) PCT Filed: Jun. 20, 2019
(86) PCT No.: PCT/JP2019/024449

§ 371 Date: Jan. 13, 2021

(30) Foreign Application Priority Data
Jul. 31, 2018 (JP) 2018-143683

(51) Int. Cl. H02K 11/40; H02K 11/33

(52) U.S. Cl. CPC H02K 11/40; B60H 1/3223; H02K 11/33

(57) ABSTRACT

There is provided an electric compressor capable of achieving an effective and stable noise reduction effect by making a ground pattern of a control device conductive to a housing at a short distance. An electric compressor 1 is configured so that a control board 17 and an HV filter board 18 of a control device 4 are accommodated in an accommodating section 9 configured in a housing 3, and the accommodating section 9 is closed by a cover member constituting a part of the housing 3. Ground patterns 26 to 28 configured on the control board 17 and the HV filter board 18 are made conductive to the cover member or a side wall 3A of the accommodating section 9.

### TECHNICAL FIELD

The present invention relates to an electric compressor having a control device accommodated in an accommodating section of a housing.

### BACKGROUND ART

Due to actualization of global environmental problems in recent years, hybrid cars and electric vehicles have been developed. However, in air conditioners for air-conditioning vehicle interiors of these vehicles, electric compressors each having a motor are used instead of engine-driven compressors. In that case, the vehicle is equipped with a high-voltage power supply composed of a high-voltage battery of, for example, about 300V, and a low-voltage power supply composed of a conventional battery of about 12V. A voltage obtained by converting a DC voltage of the high-voltage power supply into AC by an inverter circuit is supplied to the motor of the electric compressor by a control device. A voltage (for example, 15V or the like) obtained by switching a DC voltage of the low-voltage power supply is supplied as a power supply of the control device.

Therefore, a circuit pattern on the high-voltage side and a circuit pattern on the low-voltage side independent of the high-voltage side circuit pattern are configured on a board of the control device. Further, an accommodating section has been configured on the outer surface of a housing (casing) of the electric compressor, and the boards of the control device have been accommodated in this accommodating section.

On the other hand, there has been taken a measure of grounding each of ground patterns on the high-voltage side and the low-voltage side by making each of the ground patterns conductive to the housing (GND) via a capacitor (Y capacitor: line bypass capacitor) using any of board-fixing screws to thereby reduce EMI noise generated by switching in an inverter circuit or the like (for example, refer to Patent Document 1).

### Citation List

### Patent Documents

### Patent Document 1: Japanese Patent No. 3473853

### Patent Document 2: Japanese Patent No. 5289697

### SUMMARY OF THE INVENTION

### Problems to be Solved by the Invention

A problem however arises in that when the ground pattern of the board is made conductive to the housing by the board fixing screw as in the related art, the screw has a structure of being screwed into a metal column rising from the bottom wall of the accommodating section, thus resulting in that the distance to the housing becomes longer, the impedance cannot be sufficiently reduced with respect to the potential of the housing, and hence a noise reduction effect is hindered.

Further, a problem also arises in that since other screws for fixing the board, which are not made conductive to the ground pattern, completely float from the ground pattern of the board, the ground potential of the board is not stabilized.

The present invention has been made to solve such conventional technical problems, and an object thereof is to provide an electric compressor capable of achieving an effective and stable noise reduction effect by making a ground pattern of a control device conductive to a housing at a short distance.

### Means for Solving the Problems

An electric compressor of the present invention is configured so that a control device is accommodated in an accommodating section configured in a housing, and the accommodating section is closed by a cover member constituting a part of the housing, and is characterized in that a ground pattern configured in the control device is made conductive to the cover member or a wall of the accommodating section close to the ground pattern.

The electric compressor of the invention of claim 2 is characterized in that in the above invention, the ground pattern located in a peripheral portion of the accommodating section is made conductive to a side wall of the accommodating section, and the ground pattern located in the center portion of the accommodating section is made conductive to the cover member or a bottom wall of the accommodating section.

The electric compressor of the invention of claim 3 includes in the above respective inventions, a screw for fixing the control device to the housing, and is characterized in that the screw is made conductive to the ground pattern and made conductive to the cover member or the wall of the accommodating section close to the ground pattern.

The electric compressor of the invention of claim 4 includes in the above invention, a plurality of the screws, and is characterized in that each of the screws is made conductive to the ground pattern, the screw located in the peripheral portion of the accommodating section is made conductive to the side wall of the accommodating section, and the screw located in the center portion of the accommodating section is made conductive to the cover member or the bottom wall of the accommodating section.

The electric compressor of the invention of claim 5 is characterized in that in the above respective inventions, the ground pattern is made conductive to the cover member or the wall of the accommodating section close to the ground pattern by a conductive grounding material having elasticity.

The electric compressor of the invention of claim 6 is characterized in that in the above respective inventions, the ground pattern is made conductive to the cover member or the wall of the accommodating section close to the ground pattern through a Y capacitor.

The electric compressor of the invention of claim 7 is characterized in that in the above invention, the ground pattern is made conductive to the cover member or the wall of the accommodating section close to the ground pattern through a plurality of the Y capacitors corresponding to a frequency band of noise desired to be reduced based on noise regulation value characteristics.

### Advantageous Effect of the Invention

According to the present invention, in an electric compressor configured so that a control device is accommodated in an accommodating section configured in a housing, and the accommodating section is closed by a cover member constituting a part of the housing, a ground pattern configured in the control device is made conductive to the cover member or a wall of the accommodating section close to the ground pattern. Therefore, the ground pattern of the control device can be made conductive to the housing at the shortest distance or a shorter distance than before. This makes it possible to sufficiently lower the impedance with respect to the potential of the housing and obtain a high noise reduction effect.

In this case, the ground pattern located in the peripheral portion of the accommodating section is close to a side wall of the accommodating section, and the ground pattern located in the center portion of the accommodating section is far away from the side wall. However, since the cover member or a bottom wall of the accommodating section is located near there, for example, as in the invention of claim 2, the ground pattern located in the peripheral portion of the accommodating section is made conductive to the side wall of the accommodating section, and the ground pattern located in the center portion of the accommodating section is made conductive to the cover member or the bottom wall of the accommodating section, thereby making it possible to make the ground patterns of the control device conductive to the housing reasonably at the shortest distance or a short distance according to the position in the accommodating section.

Further, the control device is fixed to the housing by a screw, but the screw is protruded from the control device. Therefore, for example, as in the invention of claim 3, the screw is made conductive to the ground pattern and conductive to the cover member or the wall of the accommodating section close to the ground pattern, thus making it possible to easily make the ground pattern of the control device conductive to the housing.

In particular, as in the invention of claim 4, when the control device is fixed to the housing with a plurality of the screws, each of the screws is made conductive to the ground pattern and the screw located in the peripheral portion of the accommodating section is made conductive to the side wall of the accommodating section, and the screw located in the center portion of the accommodating section is made conductive to the cover member or the bottom wall of the accommodating section, whereby the respective screws can be made smoothly conductive to the housing at the shortest distance or the short distance, and further, the stabilization of a ground potential of the control device can also be achieved.

Further, as in the invention of claim 5, if the ground pattern is made conductive to the cover member or the wall of the accommodating section close to the ground pattern by a conductive grounding material having elasticity, the ground pattern of the control device can be made reliably conductive to the cover member or the wall of the accommodating section close to the ground pattern. In particular, as in the inventions of claims 3 and 4, when the screw for fixing the control device is used for conduction to the housing, the grounding material can be brought into contact with the screw, or the grounding material can be fixed to the control device by the screw and made conductive thereto, so that the ground pattern can be made more reliably and effectively conductive to the housing.

In addition, as in the invention of claim 6, if the ground pattern is made conductive to the cover member or the wall of the accommodating section close to the ground pattern through a Y capacitor, an extremely high EMI noise reduction effect can be realized.

In this case, as in the invention of claim 7, if the ground pattern is made conductive to the cover member or the wall of the accommodating section close to the ground pattern via a plurality of the Y capacitors corresponding to a frequency band of noise desired to be reduced based on noise regulation value characteristics, it is possible to take appropriate coping according to the noise frequency band and obtain a higher EMI noise reduction effect.

### BRIEF DESCRIPTION OF THE DRAWINGS

FIG. 1 is a perspective view of an electric compressor of one embodiment to which the present invention is applied;

FIG. 2 is a schematic block diagram of an electric circuit of the electric compressor shown in FIG. 1;

FIG. 3 is a plan view of the electric compressor of FIG. 1 with a cover member removed therefrom as viewed from an accommodating section side;

FIG. 4 is a sectional view taken along line A-A of FIG. 3;

FIG. 5 is a sectional view taken along line B-B of FIG. 3;

FIG. 6 is a view describing a structure of a screw portion of a board of FIG. 3; and

FIG. 7 is a sectional view showing an accommodating section of an electric compressor of another embodiment of the present invention.

### MODE FOR CARRYING OUT THE INVENTION

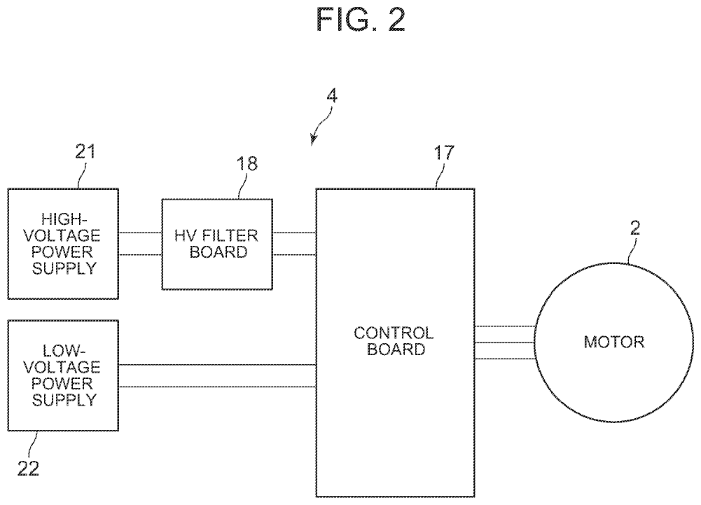

Hereinafter, embodiments of the present invention will be described in detail with reference to the drawings. In the drawings, reference numeral 1 denotes a so-called inverter-integrated electric compressor which is mounted on a vehicle such as an electric vehicle or a hybrid vehicle and configures a refrigerant circuit of a vehicle air conditioner for air-conditioning a vehicle interior, and which includes a motor 2 (shown in FIG. 2), a metal-made (conductive metal such as aluminum or iron, aluminum in the embodiment) housing 3 incorporating therein a compression mechanism (not shown) driven by the motor 2, and a control device 4 (shown in FIG. 2) which supplies power to the motor 2 to drive it.

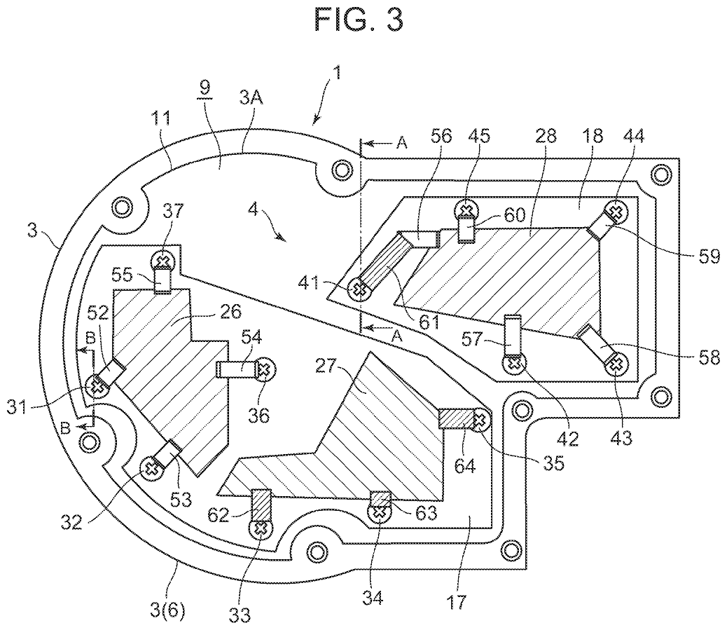

The housing 3 includes a motor housing 6 which incorporates the motor 2 therein, a compression mechanism housing 7 which is connected to one side of the motor housing 6 in its axial direction and incorporates the compression mechanism therein, a compression mechanism cover 8 which closes an opening on one side of this compression mechanism housing 7, an accommodating section 9 (shown in FIG. 3) configured on the outer surface of the motor housing 6 on the other side thereof in the axial direction, and a cover member 12 which closes an opening 11 on the other side of the accommodating section 9 so that it can be opened and closed. Then, after the control device 4 is accommodated in the accommodating section 9, the accommodating section 9 is closed by the cover member 12, and the cover member 12 is detachably attached to the motor housing 6 by screws 13. That is, in the present invention, the cover member 12 also constitutes a part of the housing 3 and is similarly made of a metal (a conductive metal such as aluminum or iron. In the embodiment, aluminum).

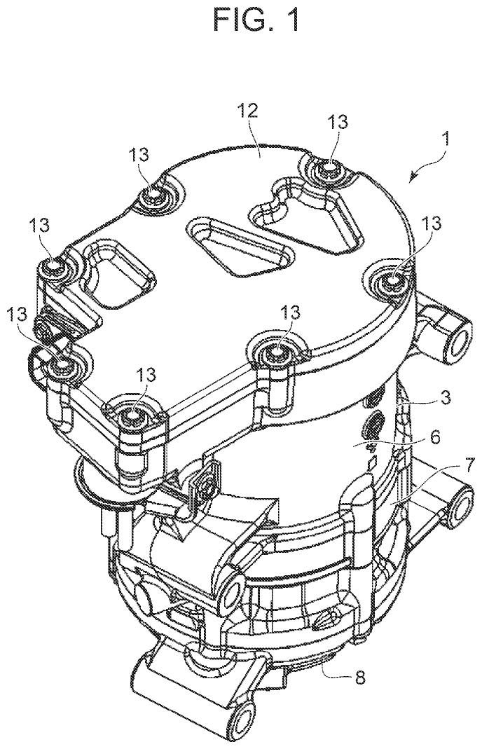

Incidentally, in FIGS. 1 and 3, the electric compressor 1 of the embodiment is shown with the accommodating section 9 up and the compression mechanism cover 8 down, but is actually arranged in the lateral direction so that the compression mechanism cover 8 is on one side and the accommodating section 9 is on the other side.

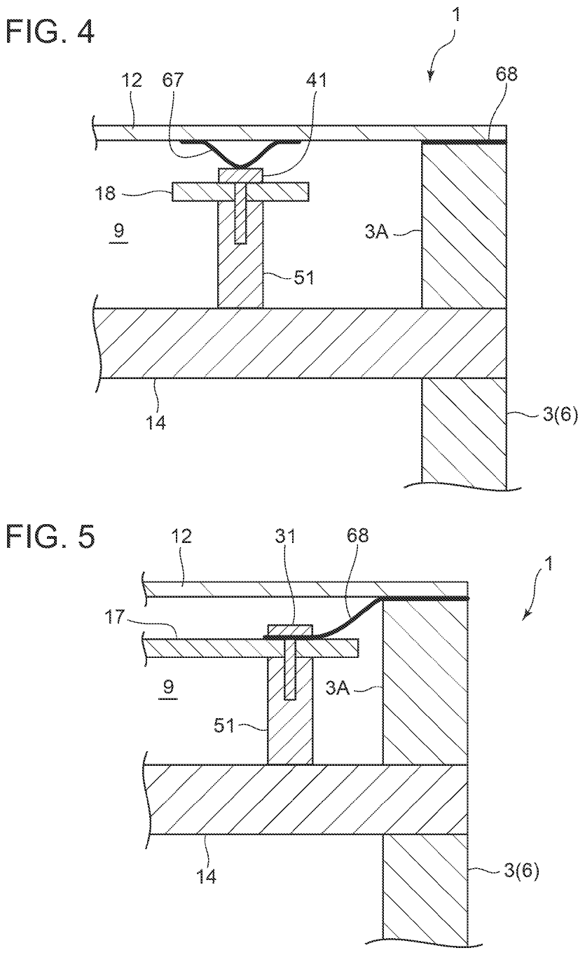

The motor 2 of the embodiment is constituted of a three-phase synchronous motor (brushless DC motor), and the compression mechanism is, for example, a scroll type compression mechanism. The compression mechanism is driven by the motor 2 to compress a refrigerant and discharge it into the refrigerant circuit. Then, a low-temperature gas refrigerant sucked from an evaporator (also referred to as a heat absorber) which also constitutes a part of the refrigerant circuit, flows through the motor housing 6. Therefore, the inside of the motor housing 6 is cooled. Then, the accommodating section 9 is partitioned from the inside of the motor housing 6 in which the motor 2 is accommodated by a partition wall 14 (the bottom wall of the accommodating section 9 shown in FIGS. 4 and 5) formed in the motor housing 6 (housing 3). The partition wall 14 is also cooled by the low-temperature gas refrigerant.

Incidentally, the vehicle is installed with a high-voltage power supply (HV power supply) 21 composed of a high-voltage battery of about DC 300V for supplying power to and driving the motor 2 of the electric compressor 1 and an unillustrated motor for running, and a low-voltage power supply (LV power supply) 22 composed of a battery of about DC 12V. Further, the housing 3 of the electric compressor 1 is made conductive to a vehicle body (ground).

The control device 4 is composed of, for example, a control board 17 and an HV filter board (EMI filter) 18. These control board 17 and HV filter board 18 constituting the control device 4 are accommodated in the accommodating section 9 configured on the outer surface of the housing 3 (motor housing 6) on the other side thereof as shown in FIG. 3. The DC voltage of the high-voltage power supply 21 is supplied to the control board 17 through the HV filter board 18. The control board 17 is provided with an inverter circuit. The inverter circuit supplies the DC voltage of the high-voltage power supply 21 to the motor 2 as an AC to operate the motor 2.

Further, the control board 17 is also supplied with the DC voltage of the low-voltage power supply 22. The control board 17 is provided with a switching power supply having a switching transformer (insulating transformer). The switching power supply switches the voltage of the low-voltage power supply 22 to generate a voltage for gate drive of the inverter circuit (for example, DC 15V) and a power supply voltage of the control device 4 itself (for example, DC 5V).

That is, a circuit pattern on the high-voltage side and a circuit pattern on the low-voltage side independent of the high-voltage side circuit pattern are configured on the control board 17. Therefore, a ground pattern 26 for high voltage and a ground pattern 27 for low voltage are formed on the control board 17 and they are insulated (FIG. 3). Further, a ground pattern 28 for high voltage is formed even on the HV filter board 18 (FIG. 3).

Further, the control board 17 is fixed to the housing 3 (motor housing 6) from the opening 11 side by a plurality of (seven in the embodiment) screws 31 to 37. The HV filter board 18 is also fixed to the housing 3 from the opening 11 side by a plurality (five in the embodiment) of screws 41 to 45. Thus, the screw heads of the screws 31 to 37 and 41 to 45 protrude from the boards 17 and 18 toward the cover member 12.

FIG. 4 shows a cross section of a screw 41 portion fixing the HV filter board 18 (cross section taken along line A-A in FIG. 3), and FIG. 5 shows a cross section of a screw 31 portion fixing the control board 17 (cross section taken along B-B in FIG. 3). Incidentally, each drawing shows a state in which the accommodating section 9 is closed by the cover member 12. Each of the screws 31 to 37 and 41 to 45 penetrates each of the boards 17 and 18, and any of them is screwed to a screw fixing column (metal column) 51 which stands upright integrally from the partition wall 14. Accordingly, the screws 31 to 37 and 41 to 45 are conductive to the housing 3 (motor housing 6).

Further, in the embodiment, the screws 31 to 35, 37, and 42 to 45 are located in the peripheral portion of the accommodating section 9. Accordingly, each of the screws 31 to 35, 37, and 42 to 45 is located near a side wall 3A (wall constituting the accommodating section 9) of the accommodating section 9, and the distance therebetween is taken to be smaller than the vertical dimension of the column 51 in the embodiment. Incidentally, the peripheral portions of the ground patterns 26 to 28 on the side wall 3A side, which become these screws 31 to 35, 37, 42 to 45 sides are close to the side wall 3A. In addition, in this embodiment, the side wall 3A is configured as a part of the housing 3 (motor housing 6). On the other hand, the screws 36 and 41 are located in the center of the accommodating section 9. Therefore, the screws 36 and 41 are separated from the side wall 3A, but the distance between each of the screws 36 and 41 and the cover member 12 is taken to be smaller than the vertical dimension of the column 51.

Further, the screws 31, 32, 36, and 37 are respectively made conductive to the high-voltage ground pattern 26 of the control board 17 through Y capacitors 52 to 55. The screws 41 to 45 are respectively made conductive to the ground pattern 28 of the HV filter board 18 through Y capacitors 56 to 60. Incidentally, the screw 41 is made conductive to the ground pattern 28 through a grounding pattern 61 and the Y capacitor 56.

On the other hand, the screws 33 to 35 are respectively made conductive to the low-voltage ground pattern 27 of the control board 17 through ground patterns 62 to 64. That is, all the screws 31 to 37 for fixing the control board 17 to the housing 3 are made conductive to the ground pattern 26 or the ground pattern 27. All the screws 41 to 45 for fixing the HV filter board 18 to the housing 3 are also made conductive to the ground pattern 28.

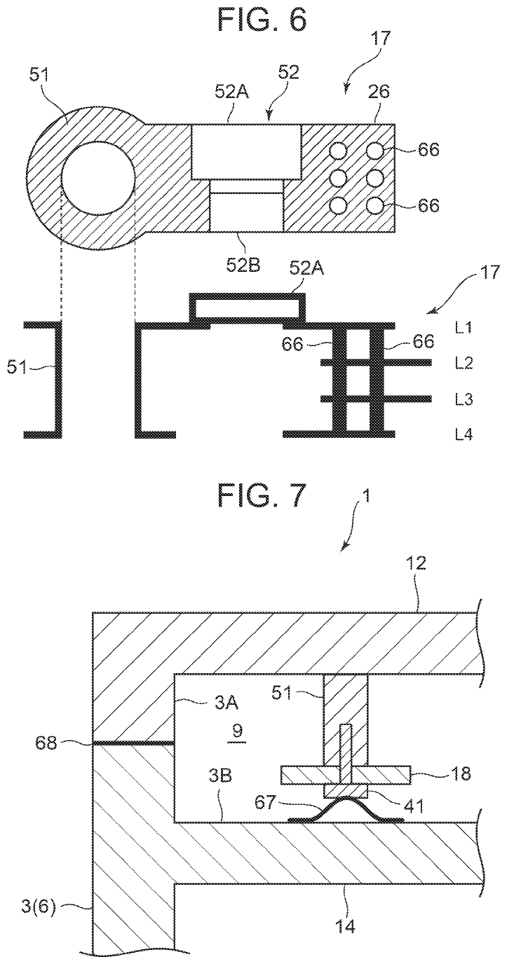

Here, FIG. 6 shows the structure of the control board 17 at the screw 31 portion, for example, in a plane (top) and a cross section (bottom). In the case of the embodiment, the control board 17 has a four-layer structure of L1 to L4. The high-voltage ground patterns 26 of the respective phases L1 to L4 are made conductive at the shortest distance at positions facing each other using a number of VIAs 66. Incidentally, such a structure is taken to be the same even for the low-voltage ground pattern 27.

Further, a plurality of (two in the embodiment) Y capacitors 52A and 52B are provided in parallel between the column 51 to which the screw 31 is screwed and the ground pattern 26. These parallel Y capacitors 52A and 52B constitute the Y capacitor 52 in FIG. 3. Each of the Y capacitors 52A and 52B has a capacity corresponding to the frequency band of noise desired to be reduced based on noise regulation value characteristics. In the embodiment, the Y capacitor 52A is for low frequency, and the Y capacitor 52B is for high frequency. Consequently, the ground pattern 26 is made conductive to the screw 31 screwed to the column 51 through the parallel Y capacitors 52A and 52B. Incidentally, such a structure is taken to be the same even for other screws 32, 36, and 37 and Y capacitors 53, 54, and 55, and the screws 41 to 45 and the Y capacitors 56 to 60 of the HV filter board 18 in FIG. 3.

Then, in the embodiment, each of the screws 36 and 41 located in the center of the accommodating section 9 is made conductive to the cover member 12 by a finger 67 as shown in FIG. 4. Each of the screws 31 to 35, 37, and 42 to 45 located in the peripheral portion of the accommodating section 9 is made conductive to the side wall 3A by a gasket 68 as shown in FIG. 5.

Each of the fingers 67 is a conductive grounding material having elasticity, and they are attached to the inner surface of the cover member 12 (the surface on the accommodating section 9 side) in advance corresponding to the positions of the screws 36 and 41, respectively. Thus, when the accommodating section 9 is closed by the cover member 12, the finger 67 comes into abuts on and contacts the screw head of each of the screws 36 and 41, and makes the cover member 12 and each of the screws 36 and 41 conductive.

Thus, the high-voltage ground pattern 26 of the control board 17 located in the center of the accommodating section 9, and the ground pattern 28 of the HV filter board 18 are made conductive to the cover member 12 by the screws 36 and 41 and the fingers 67. However, as described above, since the distance between each of the screws 36 and 41 and the cover member 12 is smaller than the vertical dimension of the column 51, each of the ground patterns 26 and 28 is made conductive to the cover member 12 (housing 3) at the shortest distance in the embodiment.

On the other hand, the gasket 68 is a member which seals between the side wall 3A of the accommodating section 9 and the cover member 12, and serves as a conductive grounding material having elasticity. In the embodiment, only the portions corresponding to the respective screws 31 to 35, 37, and 42 to 45 are protruded and extended inwardly, and are tightened and fixed to the respective ground patterns 26, 27, and 28 by the screws 31 to 35, 37, and 42 to 45 and made conductive thereto. Consequently, the side wall 3A and the respective screws 31 to 35, 37, and 42 to 45 are made conductive.

Thus, the high-voltage ground pattern 26 and the low-voltage ground pattern 27 of the control board 17, which are located in the peripheral portion of the accommodating section 9, and the ground pattern 28 of the HV filter board 18 are made conductive to the side wall 3A by the screws 31 to 35, 37, and 42 to 45 and the gaskets 68. However, as described above, since the distance between each of the screws 31 to 35, 37, and 42 to 45 and the side wall 3A is smaller than the vertical dimension of the column 51, each of the ground patterns 26 to 28 is made conductive to the side wall 3A (housing 3) at a shorter distance than where the gasket 68 is not used (where conduction is performed only by the column 51).

Incidentally, the screws 31 to 35, 37, and 42 to 45 may also be made conductive to the cover member 12 by the fingers 67 without depending on this embodiment. In the example of FIG. 5 in particular, since the screw 31 is closer to the cover member 12 than the side wall 3A, the finger 67 may be brought into abutment (contact) with the cover member 12 similarly to the screws 36 and 41 to be made conductive thereto.

As described above, in the present invention, the ground patterns 26 to 28 configured on the control board 17 and the HV filter board 18 constituting the control device 4 are made conductive to the cover member 12 or the side wall 3A of the accommodating section 9 close to the ground patterns 26 to 28. Therefore, the ground patterns 26 to 28 of the control board 17 and the HV filter board 18 of the control device 4 can be made conductive to the housing 3 at the shortest distance or a shorter distance than before. This makes it possible to sufficiently lower the impedance with respect to the potential of the housing 3 and obtain a high noise reduction effect.

Here, as in the embodiment, the ground patterns 26 to 28 located in the peripheral portion of the accommodating section 9 are close to the side wall 3A of the accommodating section 9, and the ground patterns 26 and 28 located in the center of the accommodating section 9 are far away from the side wall 3A. However, when the cover member 12 is located near there, the ground patterns 26 to 28 located in the peripheral portion of the accommodating section 9 are made conductive to the side wall 3A, and the ground patterns 26 and 28 located in the center of the accommodating section 9 are made conductive to the cover member 12, thereby making it possible to make the ground patterns 26 to 28 of the control board 17 and the HV filter board 18 conductive to the housing 3 smoothly at the shortest distance or a short distance according to the position in the accommodating section 9.

Further, as in the embodiment, when the control board 17 and the HV filter board 18 of the control device 4 are fixed to the housing 3 by the screws 31 to 37 and 41 to 45, these screws 31 to 37 and 41 to 45 are protruded from the boards 17 and 18. Therefore, the screws 31 to 37 and 41 to 45 are made conductive to the ground patterns 26 to 28 and conductive to the cover member 12 or the side wall 3A, thereby making it possible to easily conduct the ground patterns 26 to 28 of the respective boards 17 and 18 to the housing 3.

In particular, as in the embodiment, when the control board 17 and the HV filter board 18 of the control device 4 are fixed to the housing 3 with the plurality of screws 31 to 37 and 41 to 45, the screws 31 to 37 and 41 to 45 are made conductive to the ground patterns 26 to 28 and the screws 31 to 35, 37, and 42 to 45 located in the peripheral portion of the accommodating section 9 are made conductive to the side wall 3A, and the screws 36 and 41 located in the center of the accommodating section 9 are made conductive to the cover member 12, whereby the screws 31 to 37 and 41 to 45 can be made smoothly conductive to the housing 3 at the shortest distance or the short distance, and further, the stabilization of the ground potential of each of the boards 17 and 18 can also be achieved.

Further, as in the embodiment, if the ground patterns 26 to 28 are made conductive to the cover member 12 or the side wall 3A by the fingers 67 or the gaskets 68 (conductive grounding material having elasticity), the ground patterns 26 to 28 of the control board 17 and the HV filter board 18 can be made reliably conductive to the cover member 12 or the side wall 3A. In particular, as in the embodiment, when the screws 31 to 37 and 41 to 45 for fixing the respective boards 17 and 18 are used for conduction to the housing 3, the fingers 67 (grounding materials) are brought into contact with the screws 36 and 41, or the gaskets 68 (grounding materials) can be fixed to the boards 17 and 18 by the screws 31 to 35, 37, and 42 to 45 and made conductive thereto, so that the ground patterns 26 to 28 can be made more reliably and effectively conductive to the housing 3.

Further, as in the embodiment, when the control device 4 is connected to the high-voltage power supply 21 and the low-voltage power supply 22, and each of the high-voltage ground pattern 26 and the low-voltage ground pattern 27 is configured on the control board 17 and the high-voltage ground pattern 28 is configured on the HV filter board 18, an extremely high EMI noise reduction effect can be realized if the high-voltage ground patterns 26 and 28 are made conductive to the cover member 12 or the side wall 3A through the Y capacitors 52 to 60.

In this case, as in the embodiment, if the ground patterns 26 and 28 are made conductive to the cover member 12 or the side wall 3A via the plurality of Y capacitors 52A and 52B corresponding to the frequency band of noise desired to be reduced based on the noise regulation value characteristics, it is possible to take appropriate coping according to the noise frequency band and obtain a higher EMI noise reduction effect. That is, in the structure of the embodiment, a noise reduction effect of about 5 dB was obtained in the entire frequency band of 30 to 300 MHz of a Biconi antenna.

Incidentally, in the embodiment, the ground patterns 26 to 28 are made conductive to the cover member 12 or the side wall 3A via the screws 31 to 37 and 41 to 45, but not limited thereto in the inventions other than claims 3 and 4. The respective ground patterns 26 to 28 may be made directly conductive to the cover member 12 or the side wall 3A by the fingers or the gaskets shown in the embodiment.

Further, in the embodiment, the high-voltage ground patterns 26 and 28 are made conductive to the cover member 12 or the side wall 3A through the Y capacitors 52 to 60. However, the low-voltage ground pattern 27 may also be made conductive to the cover member 12 or the side wall 3A through the Y capacitor to achieve a reduction in EMI noise.

In addition, in the embodiment, as shown in FIGS. 4 and 5, the side wall 3A is configured on the motor housing 6 side of the housing 3 and the accommodating portion 9 is configured inside the side wall 3A, and the accommodating section 9 is closed by the flat plate-like cover member 12. However, a structure may be adopted in which side walls are configured on both of the cover member 12 side and the motor housing 6 side, and both sides constitute the side wall of the accommodating section 9. In that case, the side wall of the accommodating section 9 corresponds to the side wall of the cover member 12 and the side wall of the motor housing 6.

Alternatively, there may be provided a structure in which the side wall is configured only at the cover member 12 and the motor housing 6 of the housing 3 has no side wall. In that case, only the position of the accommodating section 9 is set on the outer surface of the other side of the motor housing 6 in the axial direction, and space surrounded by the cover member 12 (included in a part of the housing 3) and the motor housing 6 in a state in which the cover member 12 is attached to the motor housing 6 becomes the accommodating section 9. Further, the side wall of the accommodating section 9 also serves as the side wall of the cover member 12.

Furthermore, FIG. 7 shows the structure of another embodiment of a portion corresponding to FIG. 4. In this embodiment, there is provided a structure in which the control device 4 (the portion of the HV filter board 18 is shown in FIG. 7) is attached to the cover member 12 side. Incidentally, in this example, as described above, the side wall of the accommodating section 9 is constituted by the side wall of the cover member 12 and the side wall of the motor housing 6.

In the case of such a structure, since the screw head of the screw 41 (the ground pattern 28) faces downward, the wall of the accommodating section 9 close to the screw 41 becomes a bottom wall 3B of the accommodating section 9 (a part of the motor housing 6). Therefore, in this case, the finger 67 is attached to the bottom wall 3B, and when the accommodating section 9 is closed by the cover member 12, the finger 67 comes into abuts on and contacts the screw head of the screw 41, and hence the bottom wall 3B and the screw 41 are made conductive. Even with such a structure, the ground patterns 26 to 28 of the control board 17 and the HV filter board 18 can be made smoothly conductive to the housing 3 at the shortest distance or a short distance.

### DESCRIPTION OF REFERENCE NUMERALS

1 electric compressor
2 motor
3 housing
3A side wall
3B bottom wall
4 control device
6 motor housing
9 accommodating section
12 cover member
17 control board
18 HV filter board
21 high-voltage power supply
22 low-voltage power supply
26 to 28 ground pattern
31 to 37, 41 to 45 screw
52 to 60, 52A, 52B Y capacitor
67 finger (grounding material)
68 gasket (grounding material).

1. An electric compressor comprising:
a control device accommodated in an accommodating section configured in a housing,
wherein the accommodating section is closed by a cover member configuring a part of the housing, and
wherein a ground pattern configured in the control device is made conductive to the cover member or a wall of the accommodating section close to the ground pattern.

2. The electric compressor according to claim 1, wherein the ground pattern located in a peripheral portion of the accommodating section is made conductive to a side wall of the accommodating section, and
wherein the ground pattern located in the center portion of the accommodating section is made conductive to the cover member or a bottom wall of the accommodating section.

3. The electric compressor according to claim 1, including a screw for fixing the control device to the housing,
wherein the screw is made conductive to the ground pattern and made conductive to the cover member or the wall of the accommodating section close to the ground pattern.

4. The electric compressor according to claim 3, including a plurality of the screws,
wherein each of the screws is made conductive to the ground pattern,
wherein the screw located in the peripheral portion of the accommodating section is made conductive to the side wall of the accommodating section, and
wherein the screw located in the center portion of the accommodating section is made conductive to the cover member or the bottom wall of the accommodating section.

5. The electric compressor according to claim 1, wherein the ground pattern is made conductive to the cover member or the wall of the accommodating section close to the ground pattern by a conductive grounding material having elasticity.

6. The electric compressor according to claim 1, wherein the ground pattern is made conductive to the cover member or the wall of the accommodating section close to the ground pattern through a Y capacitor.

7. The electric compressor according to claim 6, wherein the ground pattern is made conductive to the cover member or the wall of the accommodating section close to the ground pattern through a plurality of the Y capacitors corresponding to a frequency band of noise desired to be reduced based on noise regulation value characteristics.

8. The electric compressor according to claim 2, including a screw for fixing the control device to the housing,
wherein the screw is made conductive to the ground pattern and made conductive to the cover member or the wall of the accommodating section close to the ground pattern.

9. The electric compressor according to claim 2, wherein the ground pattern is made conductive to the cover member or the wall of the accommodating section close to the ground pattern by a conductive grounding material having elasticity.

10. The electric compressor according to claim 3, wherein the ground pattern is made conductive to the cover member or the wall of the accommodating section close to the ground pattern by a conductive grounding material having elasticity.

11. The electric compressor according to claim 4, wherein the ground pattern is made conductive to the cover member or the wall of the accommodating section close to the ground pattern by a conductive grounding material having elasticity.

12. The electric compressor according to claim 2, wherein the ground pattern is made conductive to the cover member or the wall of the accommodating section close to the ground pattern through a Y capacitor.

13. The electric compressor according to claim 3, wherein the ground pattern is made conductive to the cover member or the wall of the accommodating section close to the ground pattern through a Y capacitor.

14. The electric compressor according to claim 4, wherein the ground pattern is made conductive to the cover member or the wall of the accommodating section close to the ground pattern through a Y capacitor.

15. The electric compressor according to claim 5, wherein the ground pattern is made conductive to the cover member or the wall of the accommodating section close to the ground pattern through a Y capacitor.
